(19) United States
(12) Patent Application Publication
(10) Pub. No.: US 2009/0014623 A1
(43) Pub. Date: Jan. 15, 2009

(54) Electrophoretic Casting

(76) Inventors: Douglas M. Matson, Belmont, MA (US); Rakesh Venkatesh, Medford, MA (US); John MacChesney, Lebanon, NJ (US); Thomas Stockert, Millburn, NJ (US)

Correspondence Address: Patent Group;Choate, Hall & Stewart LLP, Two International Place, Boston, MA, 02110, US

(21) Appl. No.: 10/585,564

(22) PCT Filed: Jan. 7, 2005
(86) PCT No.: PCT/US05/00505

§ 371 Date: Jul. 6, 2006

Related U.S. Application Data
(60) Provisional application No. 60/535,300, filed on Jan. 9, 2004.

(51) Int. Cl. B28B 7/34; C09D 5/44; C25D 13/02

(52) U.S. Cl. 249/134; 204/509; 204/507; 204/484

(57) ABSTRACT

Methods for electrophoretic deposition of molds for casting processes are provided. Electrophoresis is used to deposit very fine particles on a template from a slurry comprising an ionic dispersion agent. The resulting green shell is then dried and sintered to form a mold.

### FIELD OF THE INVENTION

The present invention relates to molding and casting methods using sols to form ceramic molds, and in particular, to methods of creating molds using electrophoretic deposition of ceramic powders from sols.

### BACKGROUND OF THE INVENTION

Current research into microelectromechanical systems (MEMS) is providing a variety of submicron devices useful in a broad range of fields. However, current MEMS technology is focused almost exclusively on silicon, and generally uses slow micromachining techniques that are not suitable for mass production of parts. Current micromachining techniques include silicon micromachining, LIGA, microcasting, and microstereolithography (MSL), further discussed below. However, none of these processes is really suitable for mass production, limiting the use of MEMS to a few highly specialized applications where the expense of such techniques can be tolerated.

### Silicon Micromachining

Two major categories exist in silicon micromachining: surface micromachining, in which micromechanical layers are formed from layers and films deposited on the wafer surface and bulk micromachining, in which structures are etched into the silicon substrate.

In surface micromachining, a silicon dioxide layer is etched and subsequently layered with polycrystalline silicon a number of times to create a layered structure. Using this sequential layering technique, it is possible to create silicon patterns that are up to 30 μm thick. Surface micromachining produces only planar structures, whereas bulk micromachining can produce thicker structures, up to 500 μm thick. To avoid undercutting, an anisotropic wet etchant, such as KOH is often utilized. The result is typically an angled sidewall, (54.74° measured from a (100) surface orientation.)

Standard silicon micromachining techniques are often not sufficient when vertical walls of high aspect ratios are required. Deep reactive ion etching (DRIE) has been successfully employed for production of flat parts that may be stacked to form 3-D structures. Etch depths are typically on the order of 100 μm with aspect ratios approaching 10.

### LIGA

When it is desirable to create high-aspect-ratio features, structures with heights of up to one millimeter and a lateral resolution down to 0.2 μm can be created by use of the LIGA Process (“Lithographie, Galvanoformung und Abformung,” German for “lithography, electroplating and molding”). In the LIGA process, deep X-ray lithography of a thick photoresist such as SU-8 is used to create a mold on the wafer. The mold is subsequently electroplated with nickel, or other metals, to make a metal part or a metal mold for plastics molding. German researchers have used the technology to create microparts out of plastics, metals, and some ceramics. The technology has slowly gained popularity in industry. MIMOTEC SA, a company located in Sion Switzerland, utilizes the LIGA process to manufacture components for watches and other devices. The LIGA process however, limits the company to vertical sidewalls only.

The main disadvantages to the LIGA process are cost and time. Access to X-ray sources is quite limited at this time; as such systems are often found only at large research centers because of their high cost. Electroplating can take extended periods of time, and does not appear to be optimal to mass production of metal components with significant structure (some simple shapes may be formed for plastic injection processes).

Microcasting Techniques

As a low cost alternative to LIGA alone, a number of casting techniques have been developed in the fabrication of non-silicon microsystems. The basic concept to all these methods is similar in that a silicon master part/mold is replicated in a series of (often destructive) processing steps. Sandia Labs in Livermore Calif. have conducted extensive research into part replication from LIGA molds. As part of these efforts, stainless steel MEMS components were fabricated using powder metallurgy techniques from a nanoparticulate that was cast into PMMA and silicone rubber molds. After shrinkage during sintering, the minimum features were on the order of 10 μm, and the structures ranged from 0.1-10 mm, with a thickness of 90 μm. The NSF Center for Advanced Manufacturing and Packaging of Microwave, Optical, and Digital Electronics (CAMPMODE), at the University of Colorado, Boulder, has done microcasting research for ceramic components. In their work, a liquid polymer precursor (Ceraset) was cast into molds with desired structures, and later converted to a ceramic by thermal decomposition of the polymer. The process produced ceramic parts with features as low as 50 μm, and thicknesses up to 142 μm.

In an effort to deal with cracking problems associated with demolding of the ceramic parts produced, researchers at the NSF CAMPMODE developed an additional casting technique based on microforging of aluminum foil over silicon/SU-8 features. The forged aluminum molds produced low-aspect ratio parts with minimum features between 50-100 μm, and rounded edges.

At the University of Michigan, Plastic Microfluidics devices were cast from a silicon mold. This technique produced microfluidics devices with features and thicknesses of 50 μm. According to the author, the casting of polymers in this method gave <1 μm replication, and surface roughness of <300 Angstroms.

Each of the above mentioned methods have shown promise in that the use of casting techniques has proven viable in terms of high replication resolution and relatively low capital costs. However, none of these methods can be directly applied in an industrial setting where mass production is theme. The inherent weakness to each of the above microcasting techniques is that the processes are dependent on highly labor-intensive methods of duplicating silicon molds into the desired material components. Automation of such processes would require equipment for each of the several processing steps, thus requiring a far more capital-intensive process. In addition to the cost, the silicon micromachined originals are limited to two-dimensional shapes with vertical sidewalls. Truly three-dimensional components, having geometry that varies in the x, y, and z directions, have not yet been demonstrated using these technologies.

Currently, the leading method for producing Microsystems with truly 3-dimensional features is microstereolithography (MSL). The process is similar to traditional stereolithography (SL) in which a laser beam is used to crosslink a liquid monomer into a polymer at the beam's focus point. The process is most widely known in the rapid prototyping industry, where software is used to translate a CAD file into a number of layers, which are built sequentially by the stereolithography apparatus (SLA). Two major categories exist in MSL: scanning and projection.

In scanning MSL, the resin is cured at the focus point of the UV laser that creates each layer line-by-line, similar to the movements of a CNC router. Once a layer is complete, the next layer is created, and the process is repeated as many times as necessary, with each layer being 5 μm thick. Although some residual surface steps may be visible, the ability to fabricate 3-D structures has been successfully realized using this technique.

A variation of scanning MSL was created in Japan using a technique known as Two Photon MSL. The Two Photon Photopolymerization technique utilizes two sources which focus at the same point within the monomer, (not at the surface) resulting in <1 μm resolution. The process was modified to obtain even higher resolution (as low as 150 nm).

In projection MSL, instead of curing a spot-line-layer, the resin is cured one complete layer at a time. This is accomplished with the use of a mask projection technique. To avoid the high costs of permanent masks (hundreds would be required in a typical MSL part), a dynamic mask generator has been produced. The technique utilized an LCD display as the mask, which was dynamically generated by software. This technique has been commercialized somewhat by the Department de Microtechnique, (DMT at the EPFL) in Switzerland, with small rapid prototyping companies such as Proform, also in Switzerland (EPFL & Proform). The now commercially available process at Proform has a resolution of 5 μm, creates 5 μm layers, and can produce parts with maximum outer dimensions of 7×10×30 mm.

Thus far, MSL techniques have shown promise for the production of 3-D polymer devices. However, the cost associated with the parts is quite high when taken in the context of a mass production setting. If one was more concerned with development of a product, MSL does show great promise in the area of rapid prototyping, where a part can be made in days for a few hundred dollars. This is much cheaper than prototyping from silicon processing techniques, where one mask alone costs more than the MSL part. Current MSL techniques can only produce parts out of polymers, thus, any other material must somehow be replicated from the MSL master. No cost-effective techniques for such replication are currently available.

### SUMMARY OF THE INVENTION

In one aspect, the invention comprises a method of forming a shell on a template. The shell is formed by immersing the template in a slurry of colloidal ceramic particles containing a salt, where the salt is present in sufficient quantity to impart an effective charge to the particles. A voltage is then applied to the template, causing the particles to be deposited on the template to form a green shell. The green shell is then sintered to increase its mechanical integrity to form a solidified shell. The template may comprise a conductive material, or it may comprise a conductive coating (e.g., a sputtered coating). The solution may be nonaqueous (e.g., butanol, methanol, ethanol, propanol, or any solution having a dielectric breakdown voltage greater than about 50 VDC). The colloidal ceramic particles may comprise silica, glass, alumina, silicon nitride, silicon carbide, yttria, zirconia, or an oxide or nitride of aluminum or titanium. The particle size may be, for example, 75 μm, 40 μm, 10 μm, 1 μm, 100 nm, or 10 nm. The dissolved salt may be, for example, a metal halide or carbonate, for example, sodium chloride, potassium chloride, rubidium chloride, cesium chloride, zinc chloride, potassium carbonate, or any metal salt or alkyl halide, and may be present in a concentration of up to 5% by weight. The salt may be at or below its saturation limit in the slurry. The applied voltage may be about 100 V, and may produce a current of about 3-5 mA. The green shell may be 50%, 60%, or 70% dense (i.e., having a pore fraction of 50%, 40%, or 30% by volume, respectively), and may be dried before sintering. The method may also include second immersing and voltage-applying steps, to deposit more colloidal particles from a second plurality onto the green shell to increase its thickness.

In another aspect, the invention comprises a method of producing an article, by providing a template having a predetermined shape, depositing an investment mold on the template, removing the template, and casting the desired article in the investment mold. The investment mold is deposited by immersing the template in a slurry of colloidal particles containing a salt (the salt being present in a quantity sufficient to impart an effective charge to the particles), applying a voltage to the template, thereby causing the charged particles to be deposited on the template to form a green shell, and sintering the green shell to form the investment mold. The template may comprise a conductive material, or it may comprise a conductive coating (e.g., a sputtered coating). The solution may be nonaqueous (e.g., butanol, methanol, ethanol, propanol, or any solution having a dielectric breakdown voltage greater than about 50 VDC). The colloidal particles may comprise silica, glass, alumina, silicon nitride, silicon carbide, yttria, zirconia, or an oxide or nitride of aluminum or titanium. The particle size may be, for example, 75 μm, 40 μm, 10 μm, 1 μm, 100 nm, or 10 nm. The salt may be, for example, a metal halide or carbonate, for example, sodium chloride, potassium chloride, rubidium chloride, cesium chloride, zinc chloride, potassium carbonate, or any metal salt or alkyl halide, and may be present in a concentration of up to 5% or 10% by weight. The applied voltage may be about 100 V, and may produce a current of about 3-5 mA. The green shell may be 50%, 60%, or 70% dense (i.e., having a pore fraction of 50%, 40%, or 30% by volume, respectively), and may be dried before sintering. The method may also include second immersing and voltage-applying steps, to deposit more colloidal particles from a second plurality onto the green shell to increase its thickness.

In yet another aspect, the invention comprises a method of producing a desired article by investment casting. The method includes providing a master template having a predetermined shape, using the master template to produce a transfer mold comprising a flexible material, the transfer mold having a shape complementary to the master template, molding a sacrificial template in the transfer mold, depositing an investment mold on the sacrificial template, and casting the desired article in the transfer mold. The sacrificial template comprises a material that can be melted, burned, or leached, and is removed by melting, burning, or leaching, without damaging the investment mold. The investment mold is formed by immersing the sacrificial template in a slurry of colloidal particles containing a salt, the salt being present in a quantity sufficient to impart an effective charge to the particles, applying a voltage to the template, thereby causing the charged particles to be deposited on the template to form a green shell, and sintering the green shell to form the investment mold.

In still another aspect, the invention comprises a casting mold, comprising a hollow shell comprising a plurality of partially or fully sintered particles and a measurable quantity of salt residue. The particle size may be, for example, 75 μm, 40 μm, 10 μm, 1 μm, 100 nm, or 10 nm, and the salt residue may comprise a metal halide or carbonate, for example, sodium chloride, potassium chloride, rubidium chloride, cesium chloride, zinc chloride, or potassium carbonate.

In yet still another aspect, the invention comprises a casting mold, produced by immersing at least a first portion of a template in a first slurry of colloidal particles containing a salt, the salt being present in a quantity sufficient to impart an effective charge to the particles, applying a voltage to the template, thereby causing the charged particles to be deposited on at least the first portion of the template to form a green shell, and sintering the green shell to form the casting mold. The colloidal particles may comprise silica, glass, alumina, silicon nitride, silicon carbide, yttria, zirconia, or an oxide or nitride of aluminum or titanium. The particle size may be, for example, 75 μm, 40 μm, 10 μm, 1 μm, 100 nm, or 10 nm. The salt may be, a metal halide or carbonate, for example, sodium chloride, potassium chloride, rubidium chloride, cesium chloride, zinc chloride, potassium carbonate, or any other metal salt or alkyl halide. The green shell may be 50%, 60%, or 70% dense (i.e., having a pore fraction of 50%, 40%, or 30% by volume, respectively). The green shell may comprise a plurality of layers of particles, where adjacent layers of particles differ in size distribution or composition. The casting mold may be further produced by, before sintering the green shell, immersing the template in a second slurry comprising a plurality of colloidal particles and allowing the slurry to dry, thereby causing the colloidal particles to be deposited over the template, including the first portion of the template on which the charged particles from the first slurry had been deposited. This deposits a green shell over the entirety of the template, including the originally coated first portion.

The term “slurry,” as it is used herein, is intended to denote a mixture of solid and liquid components. Slurries may be solutions, suspensions, or combinations thereof, and may include multiple solids and liquids.

### BRIEF DESCRIPTION OF THE DRAWING

The invention is described with reference to the several figures of the drawing, in which,

FIG. 1 shows the steps of three processes for microtooling fabrication using sol-based techniques; and

FIG. 2 is a schematic of the steps of the electrophoretic deposition process.

### DETAILED DESCRIPTION

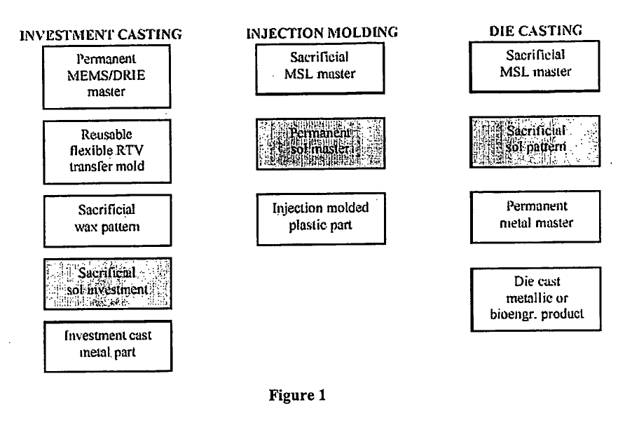

The present invention provides sol-based ceramic molds that may be used in any of several microfabrication techniques. The steps of three such techniques are illustrated schematically in FIG. 1: investment casting, injection molding, and die-casting. Each technique starts with a “master” part made by prior art microfabrication techniques, such as DRIE or MSL. The high cost of producing such a master is amortized over the many low-cost parts that can be made by using these multistep processes. Investment casting uses the greatest number of steps, but also has the potential to make the largest number of cast parts from a single master. In this technique, a complement of the master is produced using a transfer mold (for example, made of silicone rubber or another flexible material). The transfer mold is then used to make a sacrificial wax pattern in the same shape as the master. (While wax is conventionally used in investment casting, any material that can be melted, burned, or leached out of the ceramic mold may be used, e.g. plastic or other organics, leachable salts, or aluminum or other relatively low melting-point metals). This sacrificial pattern is coated with the sol investment using the techniques described below, and the wax is melted out or otherwise removed to form a hollow ceramic shell. This hollow shell is then filled with molten metal (or plastic) to create the final casting. The shell can be broken off or otherwise removed from the final casting as further described below.

In the other two processes shown in FIG. 1, the master is “sacrificial”—that is, it will usually be destroyed by the initial step of the process. In injection molding, the master is coated with the sol-based ceramic as described below to form a permanent ceramic mold, which may be used to form a plurality of injection-molded plastic parts. (Those of ordinary skill in the art will see that appropriate parting lines and mold release agents must be employed in the injection molding step in order to preserve the integrity of the ceramic mold).

In the illustrated die-casting process, the initial master is actually a complement of the final product. As in injection molding, the master is directly coated with the sol-based ceramic to form a mold. This mold is then used to create a permanent metal master of the same shape as the initial master. The permanent metal master may then be used for conventional die-casting or stamping.

It will be understood by those of ordinary skill in the art that our invention is not limited to any particular casting or molding process, but may be used in any process where a ceramic shell is built up on a template. The above-described processes are simply examples of the types of casting processes that may be performed using the invention.

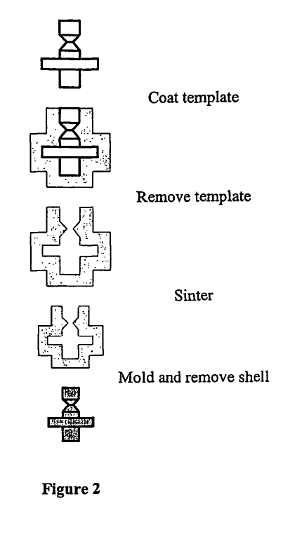

According to the invention, a shell for casting (e.g., a ceramic shell) is built up on a template by electrophoresis. This procedure is shown schematically in FIG. 2. First, the template is partially or fully immersed in a suspension of ceramic particles. A nonaqueous suspension having a low surface tension is preferred, as we have found that it minimizes cracking during the drying process (further discussed below). Butanol (e.g., isobutanol or n-butanol) is a suitable solvent; other potential solvents include methanol, ethanol, propanol, or any nonaqueous solvent having a sufficiently high dielectric breakdown voltage (preferably above 50 VDC). An ionic dispersion agent is preferably added to increase stability of the suspension (e.g., NaCl, KCl, CsCl, ZnCl, K₂CO₃, or other metal salts or alkyl halides). We have found that when depositing silica particles, good results are obtained when the ionic species is added at a concentration of at least 5-10% by weight. Borosilicate glasses may be deposited without the need for additives, but the addition of the agents increases the surface charge on the particles and increases deposition efficiency. Any material that may be dispersed in the suspension and subsequently aggregated to form a mold may be used (e.g., silica, glass, alumina, silicon nitride, silicon carbide, yttria, zirconia, or oxides or nitrides of aluminum or titanium). For best surface quality of the final molded part, the particle size of the ceramic should be small, at least for the first-deposited layers. Good surface quality has been obtained using a sol having an average particle size of about 40 μm, but particle sizes from 10 nm-75 μm have been found to be effective for use with the invention. For smaller particle sizes, it may be advantageous to deposit particles in a few layers, starting with very fine particles for the innermost layer (to enhance surface quality), and using coarser particles in subsequent layers (to speed buildup of the mold). Unlike conventional slurry techniques, layers do not generally have to be fully dried before additional layers are added to the shell.

Once the template is immersed in the slurry, a positive voltage is applied to the template, which acts as a cathode. Of course, this step requires a conductive template. The template may be made of a conductive material such as a metal or a conductive polymer, or it may be a composite of nonconductive and conductive material, or it may be coated with a conductive material. For example, a nonconductive template may be coated with a fine conductive metal layer, for example, gold, aluminum, or carbon, by sputtering.

Particles are deposited by electrophoresis on the cathodic template. For deposition of 40 μm silica in butanol with an inter-electrode separation of about 2 centimeters, preferred conditions are at a voltage of 100 V and a current of 3-5 mA. The resulting particulate layer has been found to have about 70% theoretical density (about 30% pore fraction by volume). The thickness may be controlled by the length of time that the voltage is applied; for the above conditions, an approximately 1 mm thick shell may be deposited in a time on the order of 5 minutes. Those of ordinary skill in the art will recognize that this deposition rate is extremely favorable as compared with the traditional investment casting technique of dipping in a slurry and drying successive layers, which might take several hours to achieve a comparable thickness.

Once a suitable thickness of ceramic has been built up, the green compact may be dried. It is advantageous to conduct the drying operation in a single step at ambient pressure, although intermediate drying is possible if graded composite structures are to be performed, as further discussed below. For 40 μm silica particles, drying temperatures of about 25° C. provide good results without softening the template (which could cause warpage). The use of a solvent having low surface tension helps avoid cracking during drying. As the solvent dries and leaves the pores of the shell, capillary forces may pull the individual particles closer to one another. If drying is not completely homogeneous (which is likely for a shell having significant thickness or curvature), these capillary forces may be unbalanced and may lead to cracking. The low surface tension of butanol reduces the effect of these capillary forces, minimizing cracking during the drying process.

Once the green shell is dried, the template is removed. Templates that allow destructive removal (e.g., by melting, pyrolysis/vaporization, or leaching) are preferred to prevent damage to the face-coat of the deposited layer, but physical removal is also possible for some template-shell geometries, especially if conductive mold-release agents such as graphite are used.

Finally, the deposited particles are sintered to improve the mechanical integrity of the shell. The desired degree of densification will depend on the ultimate purpose of the mold. If the shell is to be used as a mold in investment casting or as a sacrificial pattern for a patterned die, it is preferably frangible to aid in removal, and thus densification should be limited. If the shell is to serve as a surface mold for coining, if it requires resistance to thermal shock, or if it is the final product, full densification will frequently be desirable.

Sintering is preferably accomplished at relatively low temperatures to limit monolith deformation. The temperature is set low enough to preclude viscous migration of pores or bubbles, as this might physically change the shape of the shell. Silica sintering may be performed at about 1200-1550° C. (e.g. at 1450° C. for four hours or at 1250° C. for twelve hours), while borosilicate glass sintering may be performed at about 850-900° C. Reactive or inert gas environments may be used, but we have found that sintering in air at ambient pressure for a duration of up to or over 18 hours with furnace cooling provides a well-formed product.

Those of ordinary skill in the art will understand that sintering and densification will be accompanied by a reduction in volume of the shell. With even temperature distribution and green shell density, this reduction in volume should be uniform. The volume reduction should be accounted for in designing the mold, so that the final part will be of the desired size (which will be smaller than the pattern size).

In some embodiments, electrophoretic mold fabrication may be combined with conventional dip-coating processes. As discussed above, where a conductive template is not employed, the portion of the template that is being coating by electrophoretic processes may be rendered conductive by applying a thin coat of conductive material to it. Electrophoretic coating may be conducting immediately prior to subsequent dip-coating over an entire part. Following electrophoretic coating, the entire part is dipped in a slurry of ceramic particles, for example, colloidal silica particles. The part is then dusted with dry silica (e.g., sand) and allowed to dry. The process may be repeated several times to build up the thickness of the coating.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A method of forming a shell on a template, comprising:
immersing the template in a slurry, the slurry comprising
a plurality of colloidal particles; and
a sufficient quantity of salt to impart an effective charge to the colloidal particles;
applying a voltage to the template, thereby causing the charged colloidal particles to be deposited on the template to form a green shell; and
sintering the green shell to form a solidified shell having greater mechanical integrity than the green shell.

2. The method of claim 1, wherein the template comprises a conductive material.

3. The method of claim 1, wherein the template comprises a conductive coating.

4. The method of claim 3, wherein the conductive coating is a sputtered coating.

5. The method of claim 1, wherein the slurry is nonaqueous.

6. The method of claim 5, wherein the slurry has a dielectric breakdown voltage greater than about 50 VDC.

7. The method of claim 5, wherein the slurry comprises a material selected from the group consisting of butanol, methanol, ethanol, and propanol.

8. The method of claim 1, wherein the colloidal particles comprise a material selected from the group consisting of silica, glass, alumina, silicon nitride, silicon carbide, yttria, zirconia, and oxides and nitrides of aluminum and titanium.

9. The method of claim 1, wherein the colloidal particles have an average particle size of less than 75 μm.

10. The method of claim 1, wherein the colloidal particles have an average particle size of less than 40 μm.

11. The method of claim 1, wherein the colloidal particles have an average particle size of less than 10 μm.

12. The method of claim 1, wherein the colloidal particles have an average particle size of less than 1 μm.

13. The method of claim 1, wherein the colloidal particles have an average particle size of less than 100 nm.

14. The method of claim 1, wherein the colloidal particles have an average particle size of less than 10 nm.

15. The method of claim 1, wherein the salt is selected from the group consisting of sodium chloride, potassium chloride, rubidium chloride, cesium chloride, zinc chloride, and potassium carbonate.

16. The method of claim 1, wherein the salt is a metal salt.

17. The method of claim 16, wherein the metal salt is a halide or a carbonate.

18. The method of claim 1, wherein the salt is an alkyl halide.

19. The method of claim 1, wherein the salt is present in a concentration of 5% by weight or less.

20. The method of claim 1, wherein the salt is present at a concentration in the slurry that is at or below its solubility limit.

21. The method of claim 1, wherein the applied voltage is about 100 volts.

22. The method of claim 21, wherein the applied voltage produces a current of about 3-5 mA.

23. The method of claim 1, wherein the green shell has a pore fraction not greater than 40% by volume.

24. The method of claim 1, wherein the green shell has a pore fraction not greater than 30% by volume.

25. The method of claim 1, further comprising drying the green shell prior to sintering.

26. The method of claim 1, further comprising:
after immersing the template and applying a voltage, immersing the template in a second slurry comprising a second plurality of colloidal particles; and
applying a second voltage to the template to cause the second plurality of colloidal particles to be deposited on the green shell to increase its thickness.

27. A method of producing a desired article, comprising:
providing a template having a predetermined shape;
depositing an investment mold on the template, wherein depositing comprises:
immersing the template in a slurry, the slurry comprising a plurality of colloidal particles and a sufficient quantity of salt to impart an effective charge to the colloidal particles;
applying a voltage to the template, thereby causing the charged colloidal particles to be deposited on the template to form a green shell; and
sintering the green shell to form the investment mold;
removing the template; and
casting the desired article in the investment mold.

28. The method of claim 27, wherein the template comprises a conductive material.

29. The method of claim 27, wherein the template comprises a conductive coating.

30. The method of claim 29, wherein the conductive coating is a sputtered coating.

31. The method of claim 27, wherein the slurry is nonaqueous.

32. The method of claim 31, wherein the slurry has a dielectric breakdown voltage greater than about 50 VDC.

33. The method of claim 31, wherein the slurry comprises a material selected from the group consisting of butanol, methanol, ethanol, and propanol.

34. The method of claim 27, wherein the colloidal particles comprise a material selected from the group consisting of silica, glass, alumina, silicon nitride, silicon carbide, yttria, zirconia, and oxides and nitrides of aluminum and titanium.

35. The method of claim 27, wherein the colloidal particles have an average particle size of less than 75 μm.

36. The method of claim 27, wherein the colloidal particles have an average particle size of less than 40 μm.

37. The method of claim 27, wherein the colloidal particles have an average particle size of less than 10 μm.

38. The method of claim 27, wherein the colloidal particles have an average particle size of less than 1 μm.

39. The method of claim 27, wherein the colloidal particles have an average particle size of less than 100 nm.

40. The method of claim 27, wherein the colloidal particles have an average particle size of less than 10 nm.

41. The method of claim 27, wherein the salt is selected from the group consisting of sodium chloride, potassium chloride, rubidium chloride, cesium chloride, zinc chloride, and potassium carbonate.

42. The method of claim 27, wherein the salt is a metal salt.

43. The method of claim 42, wherein the metal salt is a halide or a carbonate.

44. The method of claim 27, wherein the salt is an alkyl halide.

45. The method of claim 27, wherein the salt is present in a concentration of 5% by weight or less.

46. The method of claim 27, wherein the salt is present at a concentration in the slurry that is at or below its solubility limit.

47. The method of claim 27, wherein the applied voltage is about 100 volts.

48. The method of claim 47, wherein the applied voltage produces a current of about 3-5 mA.

49. The method of claim 27, wherein the green shell has a pore fraction not greater than 40% by volume.

50. The method of claim 27, wherein the green shell has a pore fraction not greater than 30% by volume.

51. The method of claim 27, further comprising drying the green shell prior to sintering.

52. The method of claim 27, further comprising:
after immersing the template and applying a voltage, immersing the template in a second slurry comprising a second plurality of colloidal particles; and
applying a second voltage to the template to cause the second plurality of colloidal particles to be deposited on the green shell to increase its thickness.

53. A method of producing a desired article by investment casting, comprising:
providing a master template having a predetermined shape;
using the master template to produce a transfer mold having a shape complementary to the master template, wherein the transfer mold comprises a flexible material;
molding a sacrificial template in the transfer mold, the sacrificial template comprising a material that can be melted, burned, or leached;
depositing an investment mold on the sacrificial template, wherein depositing comprises:
immersing the template in a slurry, the slurry comprising a plurality of colloidal particles and a sufficient quantity of salt to impart an effective charge to the colloidal particles;
applying a voltage to the template, thereby causing the charged colloidal particles to be deposited on the template to form a green shell; and
sintering the green shell to form the investment mold;
removing the sacrificial template by melting, burning, or leaching, without damaging the investment mold; and
casting the desired article in the investment mold.

54. A casting mold, comprising:
a hollow shell comprising a plurality of partially or fully sintered particles and a measurable quantity of salt residue.

55. The casting mold of claim 54, wherein the particles comprise a ceramic material.

56. The casting mold of claim 54, wherein the partially or fully sintered particles have an average particle size of less than about 75 μm.

57. The casting mold of claim 54, wherein the partially or fully sintered particles have an average particle size of less than about 40 μm.

58. The casting mold of claim 54, wherein the partially or fully sintered particles have an average particle size of less than about 10 μm.

59. The casting mold of claim 54, wherein the partially or fully sintered particles have an average particle size of less than about 1 μm.

60. The casting mold of claim 54, wherein the partially or fully sintered particles have an average particle size of less than about 100 nm.

61. The casting mold of claim 54, wherein the partially or fully sintered particles have an average particle size of less than about 10 nm.

62. The casting mold of claim 54, wherein the salt residue is selected from the group consisting of sodium chloride, potassium chloride, rubidium chloride, cesium chloride, zinc chloride, and potassium carbonate.

63. A casting mold, produced by:
immersing at least a first portion of a template in a first slurry, the first slurry comprising
a plurality of colloidal particles; and
a sufficient quantity of salt to impart an effective charge to the colloidal particles;
applying a voltage to the template, thereby causing the charged colloidal particles to be deposited on the template to form a green shell about at least the first portion of the template; and
sintering the green shell to form the casting mold having greater mechanical integrity than the green shell.

64. The casting mold of claim 63, wherein the colloidal particles comprise a material selected from the group consisting of silica, glass, alumina, silicon nitride, silicon carbide, yttria, zirconia, and oxides and nitrides of aluminum and titanium.

65. The casting mold of claim 63, wherein the colloidal particles have an average particle size of less than about 75 μm.

66. The casting mold of claim 63, wherein the colloidal particles have an average particle size of less than about 40 μm.

67. The casting mold of claim 63, wherein the colloidal particles have an average particle size of less than about 10 μm.

68. The casting mold of claim 63, wherein the colloidal particles have an average particle size of less than about 1 μm.

69. The casting mold of claim 63, wherein the colloidal particles have an average particle size of less than about 100 nm.

70. The casting mold of claim 63, wherein the colloidal particles have an average particle size of less than about 10 nm.

71. The casting mold of claim 63, wherein the salt is selected from the group consisting of sodium chloride, potassium chloride, rubidium chloride, cesium chloride, zinc chloride, and potassium carbonate.

72. The casting mold of claim 63, wherein the salt is a metal salt.

73. The casting mold of claim 72, wherein the salt is a halide or a carbonate.

74. The casting mold of claim 63, wherein the salt is an alkyl halide.

75. The casting mold of claim 63, wherein the green shell has a pore fraction not greater than 40% by volume.

76. The casting mold of claim 63, wherein the green shell has a pore fraction not greater than 30% by volume.

77. The casting mold of claim 63, wherein the green shell comprises a plurality of layers of particles, and wherein adjacent layers of particles differ in size distribution or in composition.

78. The casting mold of claim 63, further produced by, before sintering the green shell:
immersing the template in a second slurry comprising a plurality of colloidal particles; and
allowing the slurry to dry, thereby causing the colloidal particles to be deposited on a second portion of the template and the green shell to form a second green shell.
